(19) United States
(12) Patent Application Publication
(10) Pub. No.: US 2017/0140437 A1
(43) Pub. Date: May 18, 2017

(54) DIGITAL CONTENT GENERATION BASED ON CONTENT VIEWABILITY FORECASTING

(71) Applicant: GENESIS MEDIA LLC, New York, NY (US)

(72) Inventor: Faizan Bhat, New York, NY (US)

(21) Appl. No.: 15/055,177

(22) Filed: Feb. 26, 2016

Related U.S. Application Data
(60) Provisional application No. 62/256,957, filed on Nov. 18, 2015.

(51) Int. Cl. G06Q 30/02; H04L 29/06

(52) U.S. Cl. CPC G06Q 30/0269; H04L 67/42; G06Q 30/0246

(57) ABSTRACT

The invention provides, in some aspects, improvements to a digital data system of the type having one or more servers coupled to a plurality of client devices over a network. The improvement is for automated insertion of supplemental content into digital content transmitted by the server(s) to a client device and is characterized by selection of that supplemental content based on a conditional probability function that estimates the viewability of the inserted content—i.e., whether and for how long the user of the client device will see and otherwise have an opportunity to interact with (play, scroll, click-in, mouse-over, etc.) that content.

This application claims the benefit of U.S. Patent Application Ser. No. 62/256,957, filed Nov. 18, 2015, entitled “Digital Content Generation Based on Content Viewability Forecasting,” the teachings of which are incorporated by reference herein.

### BACKGROUND OF THE INVENTION

The invention relates to digital content delivery and more particularly, by way of non-limiting example, to the delivery of content over networks based on forecasts of content viewability. The invention has application, by way of non-limiting example, to the customization of web pages via insertion into them of selected advertisements.

With one-half billion active web sites and tens of trillions of web pages, the Internet represents a wealth of information of truly epic proportions. Some of the main and most popular content sources are web sites and web pages (collectively, “web pages”) of news, entertainment, education and other content-rich media. Though the consumers of that content are sometimes willing to open their wallets for access, i.e., through payment of one-time or recurring subscription fees, online advertising plays a critical role in sustaining the operation of the Internet. It provides advertisers with opportunities to reach potential consumers through targeted digital advertisements, consequently allowing digital media owners to monetize their digital content and products through revenue generated by the delivery of those digital advertisements to their users.

The technologies through which that online advertising is delivered is rapidly advancing to facilitate more efficient transactions between “buyers,” i.e., the advertisers who buy space for their advertisements on popular web sites and pages, and “sellers,” i.e., the owners of those sites/pages who create or bring together the content that makes them so popular. For example, “real time bidding” technology is growing in popularity as a method for fully or partially automating the buying and selling of online advertising opportunities. Real-time bidding allows sellers of digital advertising space to make new advertising opportunities available to multiple advertisers simultaneously. In real-time bidding, the suitability and price of each digital advertising opportunity is determined either through pre-existing agreements between buyers and sellers, or through an auction where various advertisers can simultaneously bid for the advertisement opportunity.

Advertisers are employing increasingly sophisticated methods for designing targeting criteria for assessing the suitability and market price of new advertising opportunities. Among those criteria are “viewability.” This refers to the portion of an ad delivered with a web page that is visible to the user, and the duration for which it is visible. Advertisers are becoming increasingly concerned about ad viewability as recent investigations show that a majority of digital ad opportunities paid for by advertisers result in outcomes where the ad was either not visible to the user, or remained visible for an low/insufficient amount of time.

The related concept of “viewable impression” is defined as a digital ad opportunity where a certain portion of content delivered to the users device was visible to the user for a certain duration of time. The exact requirements vary from advertiser to advertiser and by content format. For display ads, some advertisers consider an ad impression to be viewable if 50% of the content is visible for at least one second. Others consider it to be viewable only if 100% of the content is visible for at least that period. For video ads, some advertisers require 50% of the video player to be visible for at least two seconds, whereas others require 100% of the video player to be visible for three seconds or more. Many other standards for viewable impressions exist, and it is likely that new perspectives will form over time. Generally speaking, though, to be considered viewable, a certain portion of the ad has to be viewable for a certain period of time.

A number of viewability measurement products are used by advertisers to determine if the purchase of a digital ad opportunity resulted in a viewable impression. Increasingly, ad viewability measurements are also serving as a “currency” for online advertising, since a growing number of advertisers are only willing to pay for opportunities that resulted in a viewable impression.

Viewability measurement helps advertisers build an understanding of how various advertising opportunity characteristics are correlated with ad viewability at an aggregate level. For instance, advertisers might discover that ad opportunities on a certain website are more likely to result in viewable impressions when compared to other websites. Advertisers might also discover that ad opportunities on a particular device/website combination are more viewable than other combinations. Recently, advertisers have started to consider whether or not an ad placement is visible on the screen at the time when the corresponding ad opportunity becomes available, as an input for pricing and selecting opportunities.

Because real time bidding technologies allows sellers of digital advertising space to court multiple advertisers simultaneously and in real-time, sellers must be capable of combining a requested web page with advertising of the winning buyer within milliseconds and delivering that bundle to a requesting user over the Internet. Thus, for example, when a user clicks on a link to a web page of an online media outlet, a content owner that utilizes an automated auction to sell space on that page to competing ad agencies or other media buyers must cause the requested paged to be updated to include the advertisement of the auction winner and rapidly deliver the two (page+ad) to the user.

Although automated auction technologies have generally proven suitable for the foregoing, such cannot be said about the state of the art of determining viewability. For example, current approaches suffer from the limitation in that they are unable to accurately forecast whether a given ad opportunity will result in a viewable ad impression. This means that advertisers are unable to determine, before purchasing an ad opportunity, what portion of an advertisement that is delivered with a requested web page will be visible to users, and for how long.

In view of the foregoing, what is need are improved systems and methods for digital content delivery and, more particularly, by way of non-limiting example, improved such systems and methods for to the delivery of content over the Internet. This includes, for example, the modification of user-requested web pages to include advertisements or other supplemental digital content. The foregoing are among objects of the invention.

These and other objects of the invention are evident in the drawings and in the discussion that follows.

### SUMMARY OF THE INVENTION

The foregoing are among the objects attained by the invention, which provides, in some aspects, improvements to a digital data system of the type having one or more server digital data devices that are coupled to a plurality of client digital data devices over a network, where one or more content-requesting applications execute on one or more of the client digital data devices and where one or more content-generating applications execute on the server digital data devices. A first one of the content generating applications responds to a request received from the first content-requesting application by transmitting requested digital content to that first content-requesting application, which presents at least a portion of the requested content on the requesting client digital data device to a user thereof.

The improvement, which is for automated insertion of supplemental digital content into the requested digital content transmitted to and/or presented by the first content-requesting application, is characterized in that the first (or another) content-generating application invokes an operation to select supplemental digital content to insert into the requested content based on execution of a conditional probability function, and transmits the selected supplemental content to the content-requesting application for presentation to the user of the first client digital data device at a designated region of the requested content.

The conditional probability function estimates whether presentation of the requested content to the user of the first client digital data device will reach the designated region of the requested content and for how long It will remain there, at least partially in the user's view—or, put another way, i.e., whether and for how long the user of that device will see and otherwise have an opportunity to interact with (play, scroll, click-in, mouse-over, etc.) supplemental content inserted into that region. The probability function is based on:
(i) any of (a) interaction by the user of the first client digital data device with the content-requesting application after that application has begun presenting at least a portion of the requested content to that user on that client digital data device, and (b) the duration of presentation by the content-requesting application of at least a portion of the requested content to that user on that client digital data device, and
(ii) a correlation between
   (a) prior presentation of the designated region of the requested content by the first or other content-requesting applications to the same or other users of the first or other client digital data devices, and
   (b) any of (a) interaction by those respective users with the respective content-requesting applications after those applications had begun presenting at least a portion of the requested content to the respective user on the respective client digital data device, and (b) a duration of that presentation.

The probability function varies, e.g., with time—that is, the time elapsed after the content-requesting application has begun presenting at least a portion of the requested content to the user on the respective client digital data device. As a consequence, the selection of supplemental digital content also varies, e.g., with time. For example, content that might be selected for insertion at “Time 0,” when the requested content is first presented to the user, may differ from the content selected one, two, five, ten or thirty seconds after such presentation has begun—all by way of non-limiting example. This is advantageous over the prior art, in which any probability estimates are fixed over all time.

According to related aspects of the invention, the content-requesting application presents the selected supplemental content when presentation of the requested content to the user of the first client digital data device reaches the designated region of the requested content.

Other aspects of the invention provide a digital data system, e.g., as described above, wherein the content-generating application that transmits the selected supplemental content to the content-requesting application is a second content-generating application, and wherein the first and second content-generating applications execute on first and second server digital data devices, respectively.

Related aspects of the invention provide a digital data system, e.g., as described above, wherein at least one of the first content-generating application and the first server digital data device are associated with a content publisher, and wherein at least one of the second content-generating application and the second server digital data device are associated with an advertiser.

Still other aspects of the invention provide a digital data system, e.g., as described above, where transmittal of the selected supplemental content to the content-requesting application is invoked by execution of the requested digital content by that application.

The invention provides, in other aspects, a digital data system for automated generation of digital content from a selected combination of two or more content pieces, where that selection is based on a conditional probability function that estimates the extent to which a given user will view or otherwise interact with (e.g., play, linger over, click on, etc.) the generated piece or a given region thereof as a function of the extent to which the same or other users who have previously accessed at least a portion of the generated piece have viewed or otherwise interacted with that portion or corresponding region thereof.

In related aspects of the invention, the conditional probability function estimate is additionally based on the extent to which the user is currently interacting with a portion of a content piece that is being generated, where that extent includes any of the nature and duration of the interaction. Thus, the probability function varies with time and/or with the requesting user's other interaction(s) with the requested content. The selection of supplemental digital content can also correspondingly vary with time and/or such other interaction. In addition to reasons noted above, this is advantageous over the prior art in that, by repeatedly invoking the conditional probability function, e.g., while the user is viewing or otherwise interacting with requested content, systems and methods according to the invention can identify (i) supplemental content to best insert for presentation to the user and (ii) opportune situations during which to select such supplemental content for insertion into the requested content.

In further related aspects of the invention, the conditional probability function can be a discrete function or a continuous one.

In further related aspects of the invention, the conditional probability function is based—additionally or instead—on characteristics of the content-requesting application, the client device and/or network which the user is operating and/or via which communications with the server transpire. Further related aspects of the invention provide such systems in which the conditional probability function estimate is based on other user characteristics, e.g., age, sex, locale, etc.

According to the foregoing and other aspects of the invention, the requested piece of digital content comprises a web page, music file (or stream), video file (or stream), or other digital content, and the supplemental digital content comprises an advertisement.

In further aspects of the invention, the content-requesting application of a digital data system, e.g., as described above, executes on one of the client digital data devices, and the content-generating application executes on the server digital data device.

Further aspects of the invention provide a digital data system, e.g., as described above, in which the server digital data device maintains a log of interaction between requested pieces of digital content (or portions thereof) and users of the client digital data devices on which those pieces were requested. In related aspects, the server digital data device maintains such a log with respect to different regions of the requested piece of content and/or portion of the combined content piece.

Related aspects of the invention provide a digital data system, e.g., as described above, comprising a tracking functionality that executes on one or more of the digital data devices to monitor user interaction with the requested and/or supplemental content.

Still other aspects of the invention provide methods of operating a digital data system or a component thereof (e.g., a server digital data processor) in accord with the operations described above.

These and other aspects of the invention are evident in the drawings and in the discussion that follows.

### BRIEF DESCRIPTION OF THE ILLUSTRATED EMBODIMENT

A more complete understanding of the invention may be attained by reference to the drawings, in which:

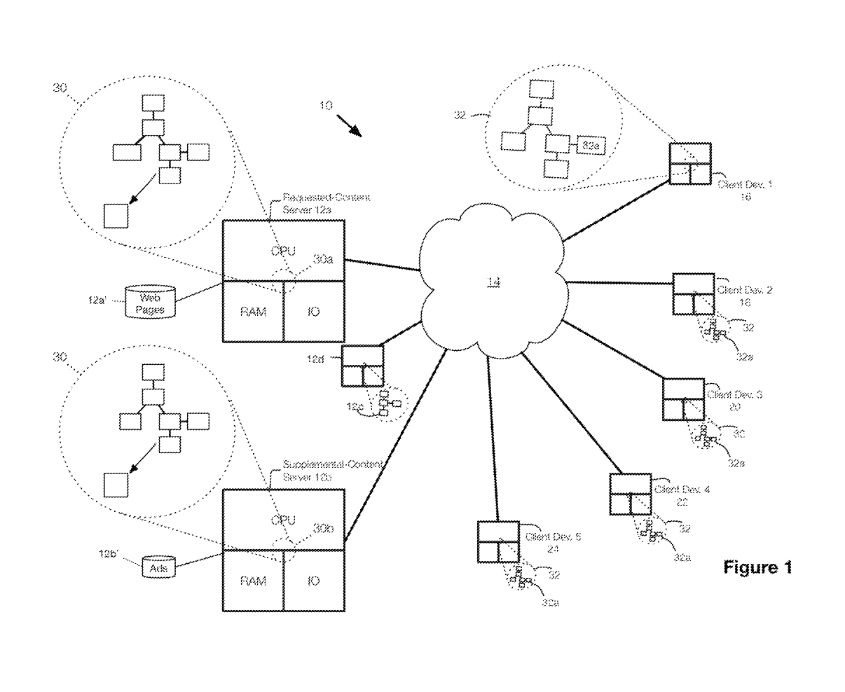

FIG. 1 depicts an improved digital data processing system according to one practice of the invention; and

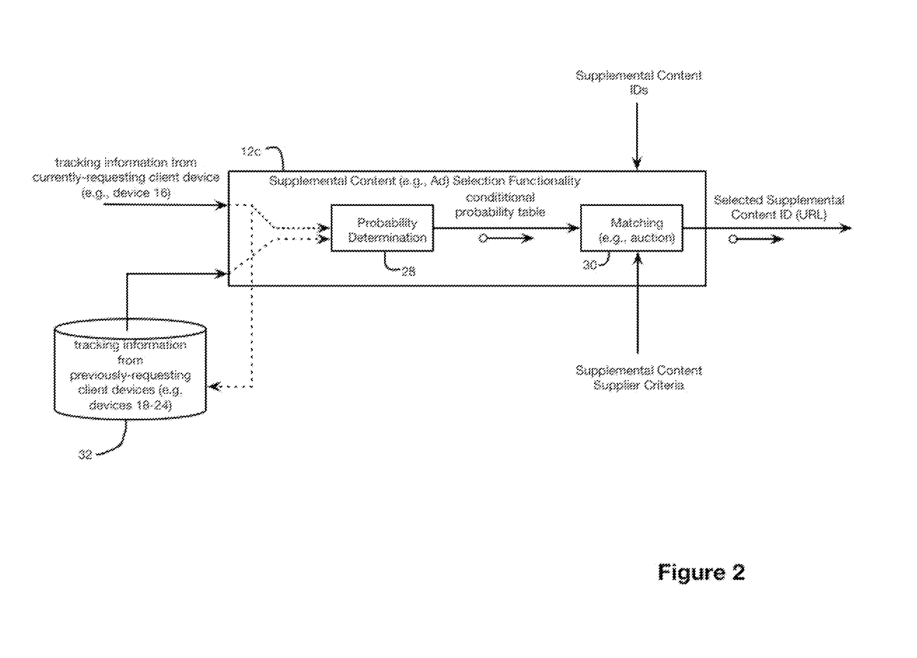

FIG. 2 depicts supplemental content (e.g., advertisement) selection functionality in a system according to the invention.

### DETAILED DESCRIPTION OF THE ILLUSTRATED EMBODIMENT

### Overview

FIG. 1 depicts an improved digital data processing system 10 according to one practice of the invention for automated selection and insertion of supplemental digital content into digital content requested by the user of a client digital device. The requested content can constitute web pages, text files, audio files, video files or other downloads, or portions thereof, requested by the client digital data device from a server digital data device, e.g., the web site or other portal of a content producer/distributer (e.g., a magazine or newspaper website, a music publisher portal and so forth). The supplemental content can include advertisements or other content sourced from the same or another server, e.g., that of an online media buyer and/or a client thereof (e.g., a local, regional or national retailer) or otherwise. Thus, by way of example, according to some practices of the invention, illustrated system 10 can be used for the automated selection and insertion of an advertisement into a news portal web page requested by a user of a browser executing on a client device.

Unlike prior art technologies, those according to the invention utilize a conditional probability function to facilitate selection of the advertisement (or other supplemental digital content) for insertion based on an estimate of whether the user will see it (or a portion of it) for at least a given period of time and/or whether the user will otherwise interact with it (e.g., via mousing-over it, clicking on it, and so forth) at a designated location in the requested content piece. The estimate is based on the behavior of the requesting user or others who have had prior access to the requested content. And, while the probability function is typically used for supplemental content selection vis-à-vis a designated location in the requested content piece, it can be used instead or in addition for selection of the location itself.

As noted above, benefits of systems and methods according to the invention include that they facilitate selection of supplemental content for insertion at a designated location in a requested content piece based on predictions of user behavior (e.g., whether and/or for how long the user will reach that location during presentation of a requested content piece on his/her respective client device). This works to the advantage of the publishers of both the requested and supplemental content pieces, as well that of the user of the client device on which those content pieces will be presented. By way of example, depending on how long the user has spent viewing a requested web page, it may be advantageous to the publisher and the user to insert a 15-second video; whereas, for other users a longer video or, perhaps, a still image might be more appropriate.

For example, if a content publisher has reserved for an advertisement space at the end of a long, multi-screen web article on skiing, the owner of a ski resort may be willing to expend resources for insertion of a video advertisement into the reserved space—but only for readers that the owner can be reasonably sure will read all the way to the end of the article. On the other hand, the owner of a mid-market hotel chain may be more willing to expend modest resources on a still-picture advertisement inserted at the end of the article even if there is only a moderate chance that users will see it. Systems and methods according to the invention make possible the selection of one of those ads over the other based on current and prior user behavior, e.g., whether and for how long the user is likely to see or otherwise interact with an advertisement inserted at the designated location—as determined from how and/or for how long the user interacts with the requested web article once it is downloaded to his/her client device. Unlike the prior art, the illustrated system 10 can make such predictions in real time, thereby, capturing variations in time (and/or user behavior) of the conditional probability function that is used, e.g., for ad or other supplemental content selection.

Turning to the drawings, Illustrated system 10 includes a requested-content server digital data device 12a and supplemental-content server digital data device 12b that are coupled via network 14 for communications with client digital data devices 16-24. Devices 12a-12b and 16-24 comprise conventional desktop computers, workstations, minicomputers, laptop computers, tablet computers, PDAs or other digital data devices of the type that are commercially available in the marketplace, all as adapted in accord with the teachings hereof. Thus, each comprises central processing (CPU), memory (RAM), and input/output (IO) subsections of the type conventional in the art, programmed and/or otherwise configured as discussed herein. The devices 12a-12b, 16-24 may be of the same type, though, more typically, they constitute a mix of devices of differing types.

Devices 12a-12b and 16-24—and, more particularly, for example, their respective central processing (CPU), memory (RAM), and input/output (IO) subsections—are configured to execute software applications (depicted, here, by flowchart icons) of the conventional type known in the art, as adapted in accord with the teachings hereof.

Examples of such applications include applications 30a and 30b executing on device 12a and 12b, respectively, comprising a web server and ad server, respectively, that respond to requests in HTTP or other protocols for transferring web pages, downloads and other digital content to the requestor over network 14—all in the conventional manner known in the art as adapted in accord with the teachings hereof. That digital content may be generated wholly from within applications 30a-30b, though, more typically, it includes content sourced from elsewhere, e.g., the illustrated databases 12a′, 12b′ (respectively) and/or file systems, or otherwise. Though referred to here as a web server and ad servers, in other embodiments applications 30a, 30b may comprise other functionality suitable for responding to client requests for transferring digital content to the requestor over the network 14, e.g., a video server, a music server, or otherwise. And, though discussed here as applications software, in other embodiments applications 30a, 30b may comprise middleware, operating system or other software, firmware, hardware or other functionality.

A further example of the applications which the aforesaid devices are configured to execute are applications 32 executing on devices 16-24 and comprising web browsers that typically operate under user control to generate requests in HTTP or other protocols for web pages, downloads and other digital content, that transmit to those requests to server applications 30a, 30b over network 14, and that present content received from the server application 30 to the user—all in the conventional manner in the adapted in accord with the teachings hereof. Though referred to here as web browsers, in other embodiments applications 32 may comprise other functionality suitable for transmitting requests to server applications 30a-30b and/or presenting content received therefrom in response to those requests, e.g., a video player application, a music player application or otherwise. And, though discussed here as applications software, in other embodiments applications 32 may comprise middleware, operating system or other software, firmware, hardware or other functionality. Illustrated applications 32 may be of the same type as one another, although, in many embodiments, they are of varied types, e.g., a mix of web browsers, music players, video players, etc. And, although in some embodiments the applications 32 may operate in partial cooperation with one another, in the illustrated embodiment they need not.

Although a single requested-content server 12a and a single supplemental-content server device 12b are depicted and described here, it will be appreciated that other embodiments may utilize a greater number of these devices, homogeneous, heterogeneous or otherwise, networked or otherwise, to perform the functions ascribed hereto to applications 30a, 30b and/or digital data processors 12a, 12b. Likewise, although several client digital data devices 16-24 are shown, it will be appreciated that other embodiments may utilize a greater or lesser number of these devices, homogeneous, heterogeneous or otherwise, running applications 32 that are, themselves, as noted above, homogeneous, heterogeneous or otherwise. Still further, in some embodiments, the operations of requested-content server 12a and the supplemental-content server 12b may be combined in a single digital data device, as may be the operations of their respective applications 30a, 30b. And, indeed, the operations of one or both of servers may be combined into those of one or more of the client digital data devices 16-24.

Network 14 comprises one or more networks suitable for supporting communications between server 12 and data devices 16-24. The network comprises one or more communications arrangements of the type known in the art, e.g., local area networks (LANs), wide area networks (WANs), metropolitan area networks (MANS), and or Internet(s).

In some regards, applications 30a, 30b (and, more generally, servers 12a, 12b) operate in the conventional manner with respect to requested and supplemental content delivered to applications 32 (and, more generally, their respective client devices) by the servers 12a, 12b in response to a requests made by those applications 32 for that content, e.g., at the behest of their respective users (i.e, users of devices 16-24).

For example, in embodiments for insertion of advertisements into web pages, a browser application (or other content-requesting client application) 32 executing on any of those client devices, say, client device 16, can at the behest of a user of that device (or otherwise) request a piece of content, say, a web page, by transmittal of an HTTP or other request to the server 12a and the respective web page server (or other requested-content serving application) 30a executing thereon. In response, the application 30a can transmit the requested web page to the requesting application 32 for display or other presentation on the respective device 16 to that user.

In the course of that display/presentation, HTML (or other) codes embedded in the web page, e.g., HTML anchor commands, can cause that application 32 to request a further piece of content, say, an advertisement, by transmittal of an HTTP or other request to the server 12b and the respective ad server (or other supplemental-content serving) application 30b executing thereon. The application 30b can, in response, transmit the designated ad to the requesting application 32, which displays or otherwise presents it in place of or in connection with the web page served-up by device 12a.

### Content Insertion

In the illustrated embodiment, application 30b (and, more generally server 12b) operates in conjunction with application 30a (and, more generally, server 12a) and/or the application 32 (and, more generally the client device, e.g., 16, on which that application is executing) to select the supplemental content for insertion into the requested content delivered to that application 32 by server 12a. To continue the example above, application 30b selects the advertisement for insertion into the web page served-up by device 12a. (For sake of simplicity, web pages and ads are the types of requested and supplemental digital content principally discussed in connection with the illustrated embodiment below, though, it will be appreciated that the teachings apply with equal force to other types of requested and supplemental digital content.)

Although such selection can be made concurrently with generation and/or delivery of the requested web page from device 12a, in the illustrated embodiment it is made after presentation of that web page has begun on the respective client device, e.g., 16. This allows for monitoring of any of (a) interaction by the user of that device 16 with that web page (via the application 32) during the presentation and/or (b) a duration of that presentation. More particularly, by way of non-limiting example, it allows for monitoring of whether the user permits the presentation to commence (e.g., as opposed to shutting down the browser 32, causing it to jump to another web page, and so forth) and, if so, for how long. It also allows for, instead or in addition, monitoring of the user's other interactions with the web page (again, via the application 32), e.g., whether the user advances the presentation out of order (e.g., by scrolling quickly to or through portions of the web page), whether the user lingers on portions of the web page, or mouses-over or clicks on them, all by way of example. Moreover, since the conditional probability function that is used for supplemental content selection varies in time and user behavior, each additional user interaction with requested content—each additional moment of time the user spends viewing that content, clicking on it, etc.—can lead to different and more appropriate supplemental content selection.

Such monitoring of the duration and/or manner of the user's interaction with the requested content can be performed continuously or discretely by tracking functionality 32a within application 32 and/or within other software operating on and/or in conjunction with the device 16 on which that application is executing. That functionality can also be performed by hidden scripts or other code contained within the requested page delivered from device 12a. Implementation of such tracking functionality, regardless of how embodied, is within the power of those of ordinary skill in the art based on the teachings hereof. In the illustrated embodiment, the tracking functionality serves as a proxy for supplemental content selection functionality executing on one or more of the server devices 12a, 12b and/or on further digital data device(s) for purpose of collecting (and transmitting to the supplemental content selection functionality discretely or continuously) information collected as a result of that monitoring.

In the drawing, the supplemental content selection functionality is designated as element 12c and is shown executing within a server 12d that is distinct from servers 12a, 12b and from client devices 16-24 (and their respective content-generating and content-requesting applications), albeit, in communication with one or more of them, e.g., via network 14. As noted, in other embodiments, element 12c can execute in whole or in part elsewhere, e.g., on servers 12a, 12b and/or one or more of the client devices, e.g., 16, instead or in addition. The tracking functionality 32a can likewise execute on server 12d by monitoring user action through hidden scripts or other code contained within requested pages delivered to the client devices 16-24, though, in the drawing, the tracking functionality 32a is shown executing on those devices only.

The tracking functionality 32a can collect other information for use by the supplemental content selection functionality, as well. That can include one or more of characteristics of the content-requesting application 32, the client digital data device 16 on which that application is executing, the network 14, the user of device 16, and the source of the requested web page. The latter can include, by way of non-limiting example, a site or other locale from which the web page is requested or sourced and/or the identity, type, and/or length of the requested web page. Characteristics of the user can include any of age, gender, and locale, again, by way of non-limiting example. Still additional characteristics that can be collected by the tracking functionality 32a are listed below in the section entitled “Advertising Opportunity Characteristics.”

In the illustrated embodiment, monitoring by the tracking functionality 32a of the duration and/or manner of the user's interaction with the requested content can begin prior to transmittal of the request by the device 16 to device 12a for the requested webpage (or other requested digital content) and can continue until after both that webpage and the supplemental content are transmitted to the content-requesting application 32 by devices 12a, 12b, respectively, and presented by that application 32 on client device 16, and the monitoring can extend to the duration and/or manner of the user's interaction with the supplemental content, once it has been delivered. In other embodiments, monitoring can begin later (e.g., upon presentation of the requested content) and can end earlier (e.g., upon selection of the supplemental content) or otherwise.

In the illustrated embodiment, the tracking functionality 32a of client device 16 is operative on client devices 18-24 in order to monitor and transmit to the supplemental content selection functionality 12c the same sorts of information as monitored by functionality 32a with respect to requested and/or supplemental content received by client device 16 from the servers 12a, 12b.

FIG. 2 depicts supplemental content selection functionality 12c, including probability determination element 28 and matching element 30. Functionality 12c accepts as input information from tracking functionality 32a of a device, e.g., client digital data device 16, that is currently requesting (and/or presenting) digital content from servers 12a, 12b, as discussed above. Functionality 12c logs that information—i.e., regarding the duration and/or manner of interaction with requested and/or supplemental content by user of the respective client device (e.g., 16)—to a database 32 that is co-housed with functionality 12c or otherwise. Functionality 12c also passes that information to probability determination element 28 and, at the same time, retrieves from a database 32 and passes to element 28 information logged to database 32 previously in connection with monitoring of the requesting device 16 or other devices (e.g., 18-24) by their respective tracking functionality 32a as they requested, received and/or presented content.

Although the supplemental content selection functionality 12c of the illustrated embodiment is utilized for selection of supplemental content for insertion into content requested by a user, in other embodiments the functionality 12c outputs a value determined from the probability determination element 28 in addition to (or instead of) identifying supplemental content for insertion into user-requested content. Thus, for example, functionality 12c (and/or element 28, directly) is utilized in some embodiments to generate and output to a requestor an estimate of the likelihood that a user that has viewed a given requested content piece for, say, X seconds (and that has, perhaps, already clicked on or moused over or taken other actions with respect to that piece) will view supplemental content being considered for insertion at a specified location in the piece.

The retrieved information is typically limited to previously-logged information in connection with requests from the other devices 18-24 for the same content as that currently being requested, received and/or presented by the currently-requesting client device 16—though, it can, of course, include such previously-logged information for the same device 16. Moreover, the retrieved information need not be limited to that for the same content as that currently being requested, received and/or presented; it can include, instead or in addition, previously-logged Information for requests having in common with the current request one or more characteristics of the type discussed above or below in the section entitled “Advertising Opportunity Characteristics,” e.g., characteristics of the content-requesting application, the client digital data device on which that application is executing, the network 14, the user of the requesting device, the identity, and the requested web page, and so forth. Though, as noted above, operations of the supplemental-content server 12b may be combined in a single digital data device with, for example, a client digital data device, e.g., 16, in many embodiments the quantity of information logged to and retrieved from database 32 for use in conditional probability determinations is too great for most client devices. In such embodiments, client devices 16-24 transmit log information to supplemental content selection functionality 12c executing on server-class device (e.g., servers 12a, 12b, and/or 12d) for storage, retrieval and use in making those determinations.

In response to information regarding the duration and/or manner of interaction by prior users with requested and/or supplemental content, probability determination element 28 generates a conditional probability function that models that interaction as a function of time and/or manner of interaction. This permits forecasting the likelihood and, more appropriately, the various likelihoods that a user of the currently requesting device, e.g., device 16, will view or otherwise interact with requested content at a designated location or region based on the duration and/or manner of his/her current interaction with that content. In the illustrated embodiment, the conditional probability function is discrete and takes the form of a conditional probability table of the type described in further detail below. In other embodiments, the function is continuous and may take other forms.

In the illustrated embodiment, the probability determination element 28 passes the conditional probability function (or table) to matching element 30 for selection of supplemental content (e.g., an advertisement) based on that function. In the illustrated embodiment, the selection is additionally made using criteria supplied with the alternative pieces of supplemental content (which are identified by ID in the drawing) from which the selection is made, e.g., typically by the suppliers of those pieces themselves. Turning back to the example, above, by way of non limiting example, selection of the still-picture advertisement of the mid-market hotel chain versus the video advertisement of the ski resort can be made from the criteria supplied by the owners of both businesses, esp., in view of the renumeration each might be willing to make to the requested content provider if those criteria are met as determined by an auction or otherwise.

In other embodiments the selection may be made on other criteria, whether dictated by the requested content providers, the supplemental content providers, transmission characteristics of the network 14, storage characteristics of the requesting device (e.g., client device 16) or otherwise. For example, where there is only a limited transmission bandwidth connection between the supplemental content server 12b and the client devices 16-24, selection of supplemental content may be made on its type (e.g., still picture versus video) in view of the conditional probability function, e.g., by way of selection logic that carries out a directive of the sort “send supplemental content that is in text or still-picture format, but only when the likelihood that he/she will read to the end requested article is greater than 30%; on the other hand, if/when that likelihood goes to 60% or higher, send supplemental content that is in video format.”

Once the supplemental content selection is made, the ID (which may be a URL) of the selected piece is transmitted to the supplemental content server for delivery of the selected piece to the requesting client device, e.g., 16, for insertion into requested content piece. In the illustrated embodiment, such insertion can be effected by the tracking functionality 32a (e.g., so that the inserted content piece is presented when relevant codes in the originally-selected content piece are executed), though, in other embodiments it may be effected in other ways.

### EXEMPLARY EMBODIMENT

Operation of the system of FIG. 1 and supplemental content selection functionality of FIG. 2 may be better appreciated from the discussion below, which focuses on use of systems and methods of the invention for selection of advertisements for insertion in to web pages requested by a users of devices 16-24. It will, of course, be appreciated that the teachings are equally applicable to insertion of other types of supplemental digital content in other types of requested content.

### Digital Advertisement Opportunities

The following terms are used in the discussion below:
“First multimedia content” (also referred to or described here as requested digital content) refers to desired multimedia content requested by the user, including but not limited to web pages and mobile applications, on an electronic device, for example, a computing device, a tablet device, a smart phone, a television, an audio player, a gaming device, etc.
“Second multimedia content” (also referred to or described here as supplemental digital content and, by way of example, as advertisements (or ads)) consists of advertisements loaded dynamically when first multimedia content is presented to the requesting user. Second multimedia content can consist of messages in various formats including but not limited to images, videos, text, animations, and other interactive elements.
Digital advertising opportunities are created when first multimedia content, e.g., a requested web page, is requested by and presented to the user via his respective client digital data device. Each advertising opportunity accepted by an advertiser can result in the delivery of second multimedia content to the user.

### Ad Placements

Ad placement refers to an area (also referred to or described here as a designated location or region) within the first multimedia content (e.g., a requested web page) that is reserved for dynamically loaded second multimedia content (e.g., a selected supplemental advertisement). First multimedia content can contain multiple ad placements. Each ad placement within the first multimedia content can be selected separately. Multiple ad placements can also be selected together.

Each ad placement has characteristics such as size, location within the first multimedia content, and second multimedia formats accepted for insertion within the placement.

### Advertising Opportunity Characteristics

Advertisers are able to observe various characteristics of new digital advertising opportunities when they become available for purchase, including but not limited to:
1. User characteristics, including but not limited to information about the user's age, gender, interests, and geographical location
2. First multimedia content characteristics, including but not limited to first multimedia content's topic, URL, theme, keywords, popularity, and quality
3. Ad placement characteristics, including but not limited to placement size, placement location within the first multimedia content, and second multimedia content formats accepted within the placement
4. Technology characteristics, including but not limited to device type, device version, browser type, browser version, and internet connection provider
5. Seller characteristics, including but not limited to seller name, seller domain name, seller IP address, seller identifier, and seller reputation

### Selection and Pricing

Advertisers (referred to elsewhere herein as owners of supplemental content and/or supplemental content servers) are prepared to expend resources (including, for example, pay money) for new digital advertising opportunities that meet criteria considered desirable to those advertisers. A plurality of “targeting” methods and tools are typically used by advertisers to select and price new digital advertising opportunities.

Targeting criteria consist of rules or combinations of rules that favor certain ad opportunity characteristics over others. Targeting criteria are selected by advertisers based on known correlations between various ad opportunity characteristics and desirable outcomes. Non limiting examples of desirable outcomes are high levels of user engagement with second multimedia content, high rate of conversion of users who view an ad into paying customers. One non-limiting example of a criteria would favor new digital advertising opportunities where the first multimedia content topic is ‘food’, ad placement is located before first multimedia content, and device type is “mobile”.

### Real Time Bidding

‘Real-time bidding’ technology (also referred to or described here as auctions) is growing in popularity as a method for fully or partially automating the buying and selling of online advertising opportunities. Real-time bidding allows sellers of digital advertising space to make new advertising opportunities available to multiple advertisers simultaneously. In real-time bidding, the suitability and price of each digital advertising opportunity is determined, at least in part, either through pre-existing agreements between buyers and sellers, or through an auction where various advertisers can simultaneously bid for the advertisement opportunity Advertisers are employing increasingly sophisticated methods for designing targeting criteria for assessing the suitability (including, for example, market price) of new advertising opportunities.

### Ad Viewability

“Ad viewability” (also referred to or described here as an ad being seen or otherwise interacted with) refers to
1. Portion of second multimedia content delivered to the user's device after the purchase of an ad opportunity that was visible to the user, and
2. Duration for which second multimedia content delivered to the user's device visible to the user.

Advertisers are becoming increasingly concerned about ad viewability as recent investigations show that a majority of digital ad opportunities paid for by advertisers result in outcomes where the second media content was either not visible to the user, or remained visible for an low/insufficient amount of time.

A “viewable impression” is defined as a digital ad opportunity where a certain portion of second media content delivered to the users device was visible to the user for a certain duration of time.

The exact requirements vary from advertiser to advertiser and by second multimedia content format. For display ads, some advertisers consider an ad impression to be viewable if 50% of the second media content is visible for at least one second. Others consider it to be viewable only if 100% of the second media content is visible for at least one second. For video ads, some advertisers require 50% of the video player to be visible for at least two seconds, whereas others require 100% of the video player to be visible for three seconds or more.

Many other standard for viewable impressions exist, and it is likely that new perspectives will form over time. Generally, however, for an advertisement to be considered viewable, a certain portion of the second multimedia content has to be viewable for a certain period of time.

### Viewability Measurement

A number of “viewability measurement” products are used by advertisers to determine if the purchase of a digital ad opportunity resulted in a viewable impression. Increasingly, ad viewability measurements are also serving as a “currency” for online advertising, since a growing number of advertisers are only willing to pay for opportunities that resulted in a viewable impression.

### Prior Art Approaches

Viewability measurement helps advertisers build an understanding of how various advertising opportunity characteristics are correlated with ad viewability at an aggregate level. For instance, advertisers might discover that ad opportunities on a certain website are more likely to result in viewable impressions when compared to other websites. Advertisers might also discover that ad opportunities on a particular device and website combination are more viewable than other combinations. Recently, advertisers have started to consider whether or not an ad placement is visible on the screen at the time when the corresponding ad opportunity becomes available, as an input for pricing and selecting opportunities.

### Prior Art Limitations

While prior art approaches help to somewhat address the issue of ad viewability, they suffer from a limitation in that they are unable to accurately forecast whether a given ad opportunity will result in a viewable ad impression. This means that advertisers are unable to determine, before purchasing an ad opportunity, what portion of second multimedia content will be visible to users, and for how long.

Based on the definition of a viewable ad impression, above, in order for an ad opportunity to result in a viewable impression, a certain portion of second media content delivered to the users device must be visible to the user for a certain duration of time. Consequently, a certain portion of the ad placement that contains the second multimedia content must be visible to the user for a certain period of time.

There are various factors that affect what portion of an ad placement is visible for a certain period of time, including, among others:
how long a user stays on the page (i.e. first media content)
where the ad placement is located on the page (e.g. top, bottom, below)
when and how the user scrolls through the first media content

The viewability of an ad opportunity depends, at least in part, on user activity prior to and after the ad opportunity is purchased

There are limitations in the way that advertising opportunities are selected and priced that make it difficult to accurately forecast whether the opportunity will result in a viewable impression
In the prior art, advertisers are only able to see characteristics of the ad opportunity, including placement visibility, at the instant in time when the opportunity becomes available. They are not able to forecast how these characteristics might change over time due to user activity For example, ad placement that was visible at the time of the ad opportunity might be invisible shortly thereafter due to the user scrolling away from the placement. In order to forecast ad viewability for a given ad opportunity, an advertiser should preferably be able to determine the likelihood of the ad placement being visible to the user over successive increments of time after the opportunity is purchased. In the illustrated embodiments, unlike in the prior art, this is achieved in part through time-series analysis of placement visibility within a first media content, starting from the time when the first media content is accessed by the user.
In the prior art, advertisers are unable to determine how much time has elapsed since the first media content was loaded by the user, at the time when the ad opportunity becomes available. Advertisers receive new ad opportunities when advertising code embedded within first media content is executed. There is a non-deterministic delay between the time when the first media content is loaded and when the related advertising code is executed. Advertisers must accept or reject the advertising opportunity within milliseconds.

### ILLUSTRATED EMBODIMENT

The illustrated embodiment provides for selecting for insertion ad opportunities by, among other things:
a) Performing a time series analysis of ad placement visibility for a given multimedia content, a given device, a given browser, etc., or a combination of these.
b) Determining at the time of the ad opportunity becoming available, the time elapsed since first multimedia content was accessed by the user, thereby allowing the supplemental content selection functionality 12c to forecast viewability before pricing and selecting the opportunity.

Among the components shown in FIGS. 1-2 and discussed above, the illustrated system has the following components: tracking, time series analysis and time elapsed bidding, as discussed below.

### Tracking

In the illustrated embodiment, code implementing the tracking functionality 32a is provided to first media content owners so that it can be embedded within first media content delivered to client devices (in response to user requests) for presentation thereon:
The tracking code detects the absolute time at which first media content is loaded by the user's device or browser
The tracking code records the absolute time at the first media content is unloaded by the users device or browser
The tracking code detects the characteristics of the user's device or browser including but not limited to the device type, device manufacturer, browser type, browser version, screen size,
The tracking code records user activity signals emitted by the user's device or browser while the first media content is visible, including but not limited to touch events, click events, and scroll events.
The tracking code determines what portion of any given ad placement is visible to the user at each instant of time after the first media content is loaded.

### Time Series Analysis

Data recorded by the tracking code are analysed by the “web service”—a term used hereinafter to refer to supplemental content selection functionality 12c and, more particularly, for example, the probability determination element 28 (which can be implemented in the servers 12a, 12b, and/or 12d as discussed above, and/or as a web service and/or otherwise. This creates various probabilistic models discussed below, e.g., the time spent, placement visibility and the viewability forecast matrices (all, collectively, also referred to and described here as a conditional probability table or, more generally, as a conditional probability function) for each ad placement analysed by the tracking code.

For example, the web service might determine that, based on all analysed data, and based on the time elapsed since first multimedia content was loaded, the likelihood that a given ad opportunity will result in a viewable impression (as per the advertisers definition of viewability) is 80%. Each time an opportunity becomes available to insert an ad into a requested web page, the web service can be invoked to determine the likely viewability of the region of the web page into which the ad is to be inserted. That information can be then be used, e.g., as described elsewhere herein to select what ad to insert and, as appropriate, pricing for such insertion.

### Time Elapsed Bidding

Probabilistic models of ad viewability created by the web service through aggregate analysis of data sent by the tracking code—both from the client device that is currently requesting a piece of content, as well as (the same or) other client devices that have previously requested that or a related page—can be used by the tracking code to make ad opportunities available at those instances in time when the likelihood of creating a viewable ad impression is maximised.

For instance, the web service might determine that the likelihood that an ad placement will remain visible for two seconds after delivery of second multimedia content increases significantly after four seconds have elapsed since the first multimedia content was loaded. This would prompt the tracking code to make ad opportunities available after four seconds have elapsed. The same infrastructure can also be used to make ad opportunities available at multiple instances in time, along with the probable viewability, so that the web service can use this information in view of the supplement content provider criteria discussed above to determine the best time to select the ad opportunity and price it accordingly.

### Viewability Forecasting for Fixed Positioned Ad Placements

Any HTML element that has a “fixed position” always stays in the same place even if the page is scrolled. Some ad placements utilise fixed positioning. As a result, 100% of the placement area is visible while first media content is being viewed by the user. In order to forecast whether second multimedia content displayed inside a fixed positioned ad placement will be viewable, the illustrated embodiment only need to forecast how long the ad placement will be in view. It is not required to forecast what portion of the ad placement area will be in view, because of the fixed positioned nature of the placement. Forecasting viewability of fixed positioned ad placements is a special case.
A method for forecasting the viewability of fixed positioned ad placements in the illustrated embodiment is as follows:
   The tracking code, embedded within first multimedia content, records the precise time when first media content is loaded (i.e. page load) and unloaded (i.e. page unload) by the user's browser or device. This information is sent to the web service, along with the following ad opportunity characteristics:
      User characteristics
      First multimedia content characteristics
      Ad placement characteristics—notably, this includes the information that the ad placement is fixed positioned
      Technology characteristics
      Seller characteristics
   The web service, which receives page load and unload information from the tracking code, is able to generate a “time spent matrix” for each characteristic, e.g., first multimedia content URL, seller domain, browser, device, etc. or combination of multiple characteristics. The time spent matrix is calculated by performing a time series analysis of data as described in the following bullets.
   For any given combination of characteristics (e.g. first multimedia content URL, device, browser), web service computes
      a percentage breakdown of content loads (i.e. page loads) based on total time spent. The results are stored as follows:
         % of content loads where time spent>1 secs
         % of content loads where time spent>2 secs
         % of content loads where time spent>3 secs
         . . . % of content loads where time spent>X secs
      Additionally, the web service computes a similar percentage breakdown of content loads based on total time spent, excluding those content loads where time spent<1 sec
      a similar percentage breakdown of content loads, excluding those content loads where time spent<2 sec
      . . . and so forth until the web service has generated a complete time spent matrix
   The following is an illustrated example of a time spent matrix

### Wherein

t=seconds elapsed since first media content is loaded
Y=total time spent
P(Y>x)=probability after t seconds have elapsed that Y is greater than x
   According to the matrix shown above, at t=0, probability that total time spent will be greater than 1 seconds is 0.68
The time spent matrix can can also be represented in a n×m dimensional matrix as follows:

$$[ \begin{matrix}.68 & 1 & 1 \\ .60 & 0.88 & 1 \\ .56 & 0.67 & 0.91\end{matrix} ]$$

The web service is able to re-compute the time spent matrix in real time, or after a certain time period, as programmed
The web service can use this matrix to determine the probability of serving a viewable fixed positioned advertisement after t seconds have elapsed
   E.g. If one second has elapsed, and the advertiser requires the ad to be visible for one second to count as a viewable impression, the web service can determine that the probability of delivering a viewable impression is 0.88 or 88%.
   The web service can also factor in the time required for the advertisement to render on the users device or browser. E.g. if the time required for the ad to fully load is 1 second, as determined by a statistical analysis of similar (e.g. by advertiser, or server, or type of ad such as display, video) ad loads in the past, the web service will determine that the probability of delivering a viewable impression is 0.67 or 67%.
The web service can also use this matrix to compute the probability of delivering a viewable impression at various instances in time (based on time elapsed since first multimedia content load), and thereby determine the most optimal times for displaying ads to maximise viewability.
   For example, as per the above matrix, assuming a one second viewability requirement and one second ad load time requirement, the likelihood of delivering a viewable ad is maximised at t=0 seconds
Note that this information is not actionable unless there is:
   a) An ability to track time elapsed since first multimedia content load. The advertising industry lacks such an ability. This functionality is provided by the tracking code.
   b) An ability to delay ad loading until some time elapsed after first multimedia content load. This ability is also provided by the tracking code.
In one embodiment, the web service transmits the time spent matrix to the tracking code embedded within the first media content, allowing the tracking code to determine the most optimal times for display ads to maximise viewability.
The web service is also able to determine, using the same time spent matrix, the likely drop off in total traffic at each increment of time (elapsed after first multimedia content load).
   E.g. Based on the first matrix, the web service can determine that 40% of first media content loads are likely to end before two seconds have elapsed since first multimedia content load
   Using this information, the web service can variably price digital ad opportunities based on a mechanism that factors in both the forecasted viewability at each time increment and the incremental traffic loss at that time increment
   In one embodiment, the tracking code, informed by the web service, makes a single digital ad opportunity available for real-time bidding (RTB) auction to advertisers with multiple viewability guarantees. E.g. Based on the matrix above, ads injected after immediately after first media content load (i.e. at t=0) will be viewable 60% of the time. However, ads injected after four seconds have elapsed since first multimedia content load will be viewable 90% of the time. Using this information, the tracking code can make a single ad opportunity available to advertisers as two separate opportunities: one with with a 60% viewability forecast, and another with a 90% viewability forecast. The tracking code determines that to meet 90% viewability, the ad must be injected after four seconds have elapsed. The probability of total time spent being greater than four seconds is also given by the time spent matrix as 46%. Conversely that likelihood that the first multimedia content will be unloaded before four seconds is 64%. In a system according to the invention that relies on an auction to facilitate ad selection, after receiving advertiser bids for both the 60% viewability forecast and the 90% viewability forecast, the web service can determine whether
      A) advertisers are willing to pay more for the 90% viewability forecast, and
      B) whether the difference in price is sufficiently greater than the 64% likelihood of off between 0 and 4 seconds.
      Based on this determination, the tracking code can decide which of the two bids to accept.

### Viewability Forecasting for Other Ad Placements

The time spent matrix described in the previous section provides one of the tools that facilitate for forecasting viewability of ad placements that are not fixed positioned (“regular ad placements”). As discussed previously, the time spent analysis can be represented as a mathematical matrix as follows:

$$[ \begin{matrix}.68 & 1 & 1 \\ .60 & 0.88 & 1 \\ .56 & 0.67 & 0.91\end{matrix} ]$$

The time spent matrix helps us understand the probability of total time spent Y after t seconds have elapsed. For regular ad placements, it's also necessary to understand what portion of the placement is visible to the user at various points in time. Each ad placement has a specific position within the first multimedia content. It's possible for the user to scroll towards and away from that position. The placement may be fully visible, partially visible, or invisible at any given point in time.

The tracking code embedded within first multimedia content is able to track what portion of HTML elements on the page, including one or many ad placements, are visible at successive increments of time after first multimedia content is loaded. This data is referred to as placement visibility data.

The tracking code passes information about visibility of the placement at each increment in time to the web service, along with the a unique placement ID, as well as ad opportunity characteristics such as user characteristics, ad placement characteristics, technology characteristics, and seller characteristics.

Example of data sent my tracking code to web service
{placement_id: 1021, time: 0 s, visibility: 100%}
{placement_id: 1021, time: 0 s, visibility: 100%}
{placement_id: 1021, time: 0 s, visibility: 90%}

The resolution of time increment for reporting can be configured: e.g. 1 second, 5 milliseconds, etc.

The web service is able to analyse all available placement visibility data to create a unique placement visibility matrix for each placement, e.g., as shown below:

| | t = 0 s | t = 1 s | t = 2 s | t = 3 s | t = 4 s | t = 5 s | t = 6 s | t = 7 s |
|---|---|---|---|---|---|---|---|---|
| P (100% visible) | 0 | 0.32 | 1.0 | 0 | 0.80 | 0.90 | 0 | 0 |
| P (50% visible) | 0 | 0.56 | 1.0 | 1 | 0.90 | 0.90 | 0 | 1.00 |

where,
t = seconds elapsed since first media content is loaded
P (100% visible) = probability that placement will be fully visible” between time t and time t − 1.
P (50% visibility) = probability that at least 50% of the placement will be visible between time t and time t − 1
Note 1:
Additional rows can be added as required. E.g. If some advertiser requires that only 10% of second multimedia content area be in view for the ad impression to count as viewable, the web service can compute P (10% visibility).
Note 2:
The time resolution can be configured so that we can do millisecond level analysis instead of second level analysis.

The web service is able to construct a placement visibility matrix for each placement where ad opportunity characteristics match those of any computed time spent matrix. For example, the web service may compute a time spent matrix for all first multimedia content loads where domain name is ‘abc.com’, device is ‘mobile’ and user's geographical location is ‘USA’. The web service can then also compute placement visibility matrix for all placements analyzed, considering only data that was captured during first multimedia content loads where domain name is ‘abc.com’, device is ‘mobile’, and user's geographical location is ‘USA’.

Each row in the placement visibility matrix can be represented as a m dimensional vector known as a “visibility vector”. For example, the first row, which computes the probability that a placement is 100% visible at various time increments can be represented as:
[0 0.32 1.0 . . . ]

The web service can create multiple “viewability forecast matrices” for each placement. Each matrix is creating by multiplying the time spent matrix with a row in the placement visibility matrix. For example, to create a viewability forecast matrix for advertisers who require 100% of the placement to be visible for a certain period of time for the placement to count as viewable, the web service can multiple the time spent matrix with a “visibility vector” corresponding to the P(100% visibility) row in the placement matrix.

The resultant viewability forecast matrix has the same applications for regular ad placements that the time spent matrix has for fixed positioned ad placements (as described in previous section).

The aforementioned customization of each requested web page is based on the forecast matrices (also referred to or described here as conditional probability functions) discussed above. In the illustrated embodiment, this provides an estimate of the likelihood that a user who has requested a web page from server 12a and who has already begun viewing it (or otherwise interacting with it, e.g., by way of scrolling, mousing, clicking, etc.) will view a designated region of the page—i.e., a region where an ad or other supplemental content is to be inserted by server 12b and is further based on whether other users who requested that web page and interacted with it, themselves, viewed the designated region.

### CONCLUSION

Described above and shown in the drawings are methods and systems meeting the aforementioned and other objects. It will be appreciated that the embodiments shown here, however, are merely examples of the invention and that other embodiments incorporating changes therein may fall within the scope thereof.

In view of the foregoing, what is claimed is:

1. In a digital data system of the type having
one or more server digital data devices that are coupled to a plurality of client digital data devices over a network,
one or more content-requesting applications executing on one or more of said client digital data devices, at least a first said content-requesting application executing on a first said client digital data device generating a request for digital content,
one or more content-generating applications, each of which is executing on a said server digital data device and which is in communications coupling with at least the first content-requesting application,
a first said content generating application responding to a said request received from the first content-requesting application by transmitting requested digital content to that first content-requesting application,
the first content-requesting application presenting at least a portion of the requested content on the first client digital data device to a user thereof,
the improvement for automated insertion of supplemental digital content into the requested digital content transmitted to and/or presented by the first content-requesting application, comprising:
A. the first or another said content-generating application that is in communications coupling with the first content-requesting application
(i) invokes an operation to select supplemental digital content to insert into the the requested content based on execution of a conditional probability function,
(ii) transmits the selected supplemental content to the content-requesting application for presentation to the user of the first client digital data device at a designated region of the requested content,
B. the content-requesting application presents the selected supplemental content when presentation of the requested content to the user of the first client digital data device reaches the designated region of the requested content, and
C. where the conditional probability function estimates whether presentation of the requested content to the user of the first client digital data device will reach the designated region of the requested content, where that estimate is based on
(i) any of (a) interaction by the user of the first client digital data device with the content-requesting application after that application has begun presenting at least a portion of the requested content to that user on that client digital data device, and (b) a duration of presentation by the content-requesting application of at least a portion of the requested content to that user on that client digital data device, and
(ii) a correlation between
(a) presentation of the designated region of the requested content by the first or other content-requesting applications to other users of the first or other client digital data devices, and
(b) any of (a) interaction by those respective users with respective content-requesting applications after those applications had begun presenting at least a portion of the requested content to the respective user on the respective client digital data device, and (b) a duration of presentation by the respective content-requesting application of at least a portion of the requested content to the respective user on the respective client digital data device.

2. The digital data system of claim 1, wherein the content-generating application that transmits the selected supplemental content to the content-requesting application is a second content-generating application, and wherein the first and second content-generating applications execute on first and second server digital data devices, respectively.

3. The digital data system of claim 1, wherein at least one of the first content-generating application and the first server digital data device are associated with a content publisher, and wherein at least one of the second content-generating application and the second server digital data device are associated with an advertiser.

4. The digital data system of claim 1, where transmittal of the selected supplemental content to the content-requesting application is invoked by execution of the requested digital content by that application.

5. The digital data system of claim 1, wherein a digital data device—other than one on which any of the content-generating and content-requesting applications execute—executes the conditional probability function so as to determine said estimate.

6. The digital data system of claim 5, wherein a digital data device—other than one on which any of the content-generating and content-requesting applications execute—measures interaction by the user of the first client digital data device with the first content-requesting application based on any of scrolling, clicking, and mousing-over.

7. The digital data system of claim 1, where the estimate of the conditional probability function is additionally based on one or more on one or more characteristics of
i. the content-requesting application,
ii. a digital data device on which the content-requesting application is executing,
iii. the network,
iv. the user,
v. the requested content,
vi. a site or other locale from which the requested content is sourced.

8. The digital data system of claim 7, wherein the user characteristics can include any of age, gender, and locale.

9. The digital data system of claim 7, in which the conditional probability function is a discrete condition probability function.

10. The digital data system of claim 1, wherein the requested content comprises any of a web page, a music file or stream, a video file or stream, and wherein the supplemental content comprises an advertisement.

11. The digital data system of claim 1, in which the first server digital data device maintains data reflecting any of (a) interaction by respective users with first or other client digital data devices on which the requested content has been presented by the first or other content-requesting applications, and (b) a duration of presentation by those respective content-requesting applications of at least a portion of the requested content to those respective users.

12. The digital data system of claim 11, in which the first server digital data device maintains said data with respect to different regions of the requested content.

13. The digital data device of claim 11, comprising a tracking application that executes on one or more of the digital data devices to monitor user interaction with the requested content.

14. The digital data device of claim 13, in which the tracking application monitors user activity with respect to at least a portion of requested content transmitted by the first content-generating application to a said client-requesting application.

15. The digital data system of claim 14, in which the tracking application performs such monitoring via proxies executing on or in connection with the respective client digital data devices.

16. The digital data system of claim 1, wherein the operation comprises an auction.

17. The digital data system of claim 1, wherein at least one of the first server digital data device and the first client digital data device assigns a monetary value to presentation of supplemental content in the designated region as a function of the conditional probability function estimate.

18. A digital data system for automated generation of digital content, comprising
A. a server digital data device that is coupled to a plurality of client digital data devices over a network,
B. a content-requesting application executing on a said digital data device, the content-requesting application generating a request for digital content,
C. a content-generating application executing on a said digital data device and in communications coupling with the content-requesting application, the content generating application responding to a said request received from the content-requesting application by
(i) selecting supplemental digital content to combine with the requested content based on execution of a conditional probability function,
(ii) transmitting a combination of the requested content and the supplemental content to the content-requesting application,
D. the content-requesting application presenting the combined content to a user for interaction therewith, and
E. where the conditional probability function estimates the extent to which the user will view or otherwise interact with at least a given region of the combined content as a function of the extent to which other users who have accessed at least a portion of the combined content have interacted with at least a region thereof corresponding to the given region.
